(19) United States
(12) Patent Application Publication
(10) Pub. No.: US 2004/0001047 A1
(43) Pub. Date: Jan. 1, 2004

(54) Wireless PDA keyboard

(76) Inventor: Sen-Cheng Wang, Taipei Hsien (TW)

Correspondence Address: BIRCH STEWART KOLASCH & BIRCH, PO BOX 747, FALLS CHURCH, VA, 22040-0747, US

(21) Appl. No.: 10/233,412

(22) Filed: Sep. 4, 2002

(30) Foreign Application Priority Data
Jun. 26, 2002 (TW) 091209614

(51) Int. Cl. G09G 5/00

(52) U.S. Cl. 345/168

(57) ABSTRACT

A wireless PDA keyboard includes a keyboard set, a control circuitry, an infrared transmitter, a battery set and a holding stand. The keyboard set is pressed to generate signals to the control circuitry that converts the signals and transmits keyboard data to PDAs with infrared transmitter, the existing PDAs infrared receiver can receive data accordingly; the direction of the infrared transmitter on the keyboard can be adjusted to fit all the PDAs with different specifications.

### BACKGROUND OF THE INVENTION

I. Field of the Invention

This invention relates generally to a wireless PDA (personal digital assistant) keyboard and, more specifically, to a wireless PDA keyboard that transmits keyboard data to PDAs with infrared transmitter. The existing PDAs infrared receiver can receive data accordingly. The direction of the infrared transmitter on the keyboard can be adjusted to fit all the PDAs with different specifications.

II. Description of the Prior Art

Heretofore, it is known that current PDAs and cellular phones with similar functions are the computers with the smallest size. They are very convenient for people to carry around to record, look for, calculate and transmit data.

However, the PDAs are small in size, therefore most of them do not have a full set of keyboard for users to input data. Some of the PDAs can input data by hand writing, others have touch screen to pick definite input from screen. But some users are familiar to keyboard as an input device so that some PDAs are equipped with external small keyboard. Most of the known external keyboards are connected with wires or cables to transmit data whereas every PDA vendor applies proprietary connector, users can not share the same keyboard with different PDA. This introduces inconvenience for users and extra cost for manufacturers in manufacturing, sales and application.

### SUMMARY OF THE INVENTION

It is therefore a primary object of the present invention to provide a wireless PDA keyboard to transmit data to PDAs with existing PDAs infrared receiver and wireless transmitter on the external keyboard; the direction of the infrared transmitter on the keyboard can be adjusted to fit all the PDAs with different specifications.

In order to achieve the objective set forth, a wireless PDA keyboard in accordance with the present invention comprises an infrared transmitter on the side housing of a revolving arm, by adjusting the location of the revolving arm to have the infrared transmitter face the infrared receiver of the PDAs with best angle with best transmission effect, further makes the keyboard set with infrared transmitter fits for all the PDAs.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a perspective view of the present invention;

FIG. 2 is an assembly view of the present invention;

FIG. 3 is an application view of the present invention;

FIG. 4 is another assembly view of another application view of the present invention;

FIG. 5 is a perspective view of another application the present invention;

FIG. 6 is another application view in accordance with the present invention.

### DESCRIPTION OF THE PREFERRED EMBODIMENT

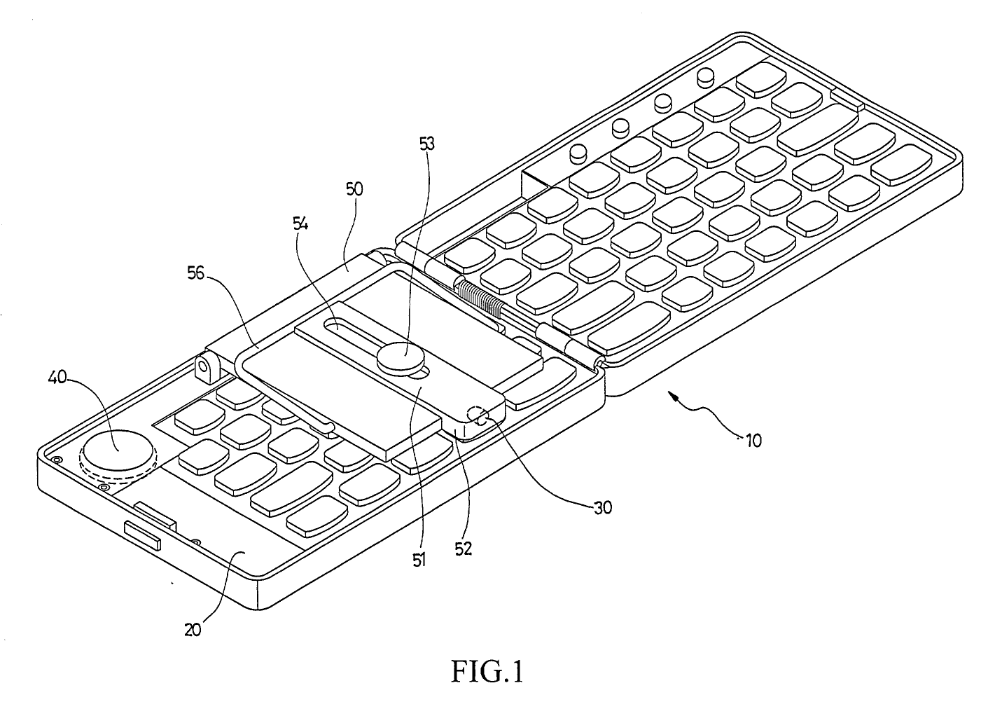

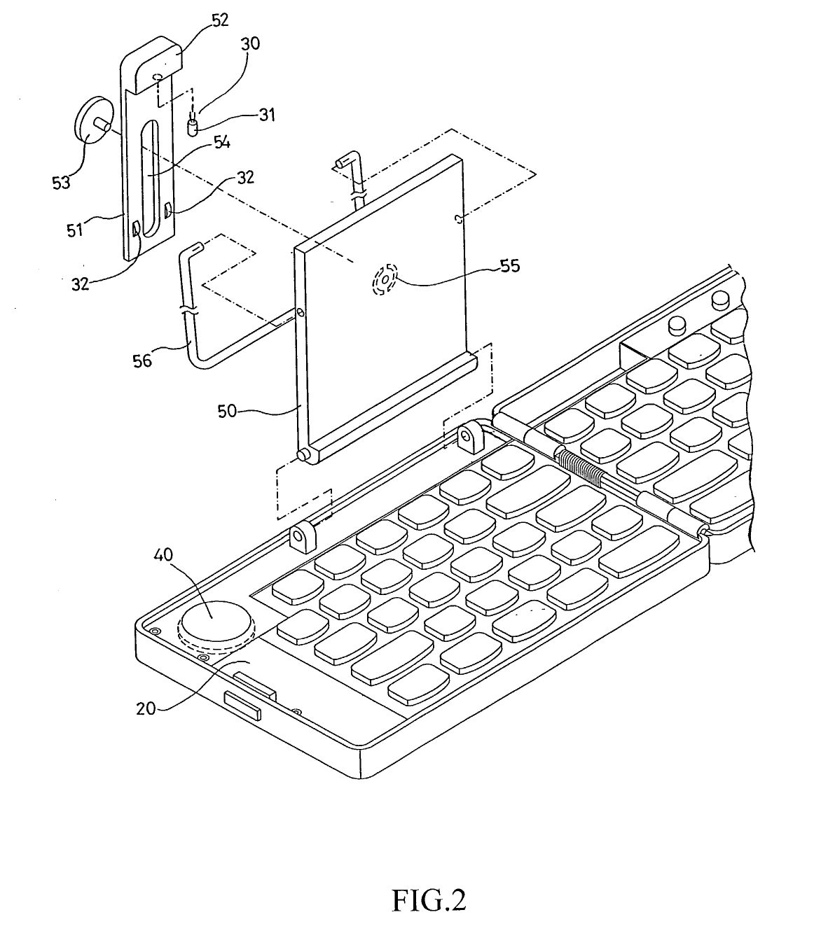

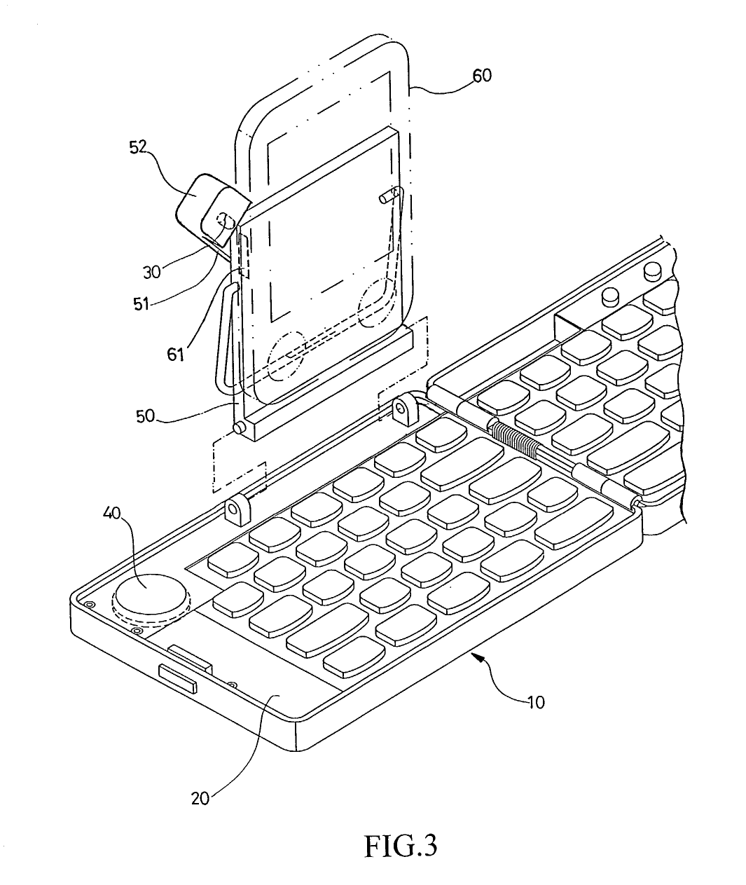

Referring to FIG. 1 and FIG. 2, the present invention is composed of a keyboard set (10), a control circuitry (20), an infrared transmitter (30), a battery set (40) and a holding stand (50). A PDA (60) with an infrared receiver (61) can be placed on the holding stand (50) (as shown in FIG. 3). The battery set (40) offers the keyboard set (10) power. When the keyboard set (10) is pressed and generates signals, the control circuitry (20) processes those signals and transmits out the processed signals through the infrared transmitter (30) wirelessly to the PDA (60), such scheme can input characters to a PDA (60). The infrared transmitter (30) is installed inside a side housing (52) of a revolving arm (51) on the back of the holding stand (50). By adjusting the direction of the revolving arm (51), the infrared transmitter (30) faces the corresponding infrared receiver (61) of the PDA (60) with the best angle.

Based on the structure described above and FIG. 3, while any type of PDA (60) is placed on the holding stand (50), users can adjust the location and direction of the revolving arm (51) of the holding stand (50) depends on the location of the infrared receiver (61) of the PDA (60). The arrangement can align the infrared transmitter (30) and the infrared receiver (61) of the PDA (60) in straight line for best transmission effect to make the keyboard set (10) fit all the PDAs.

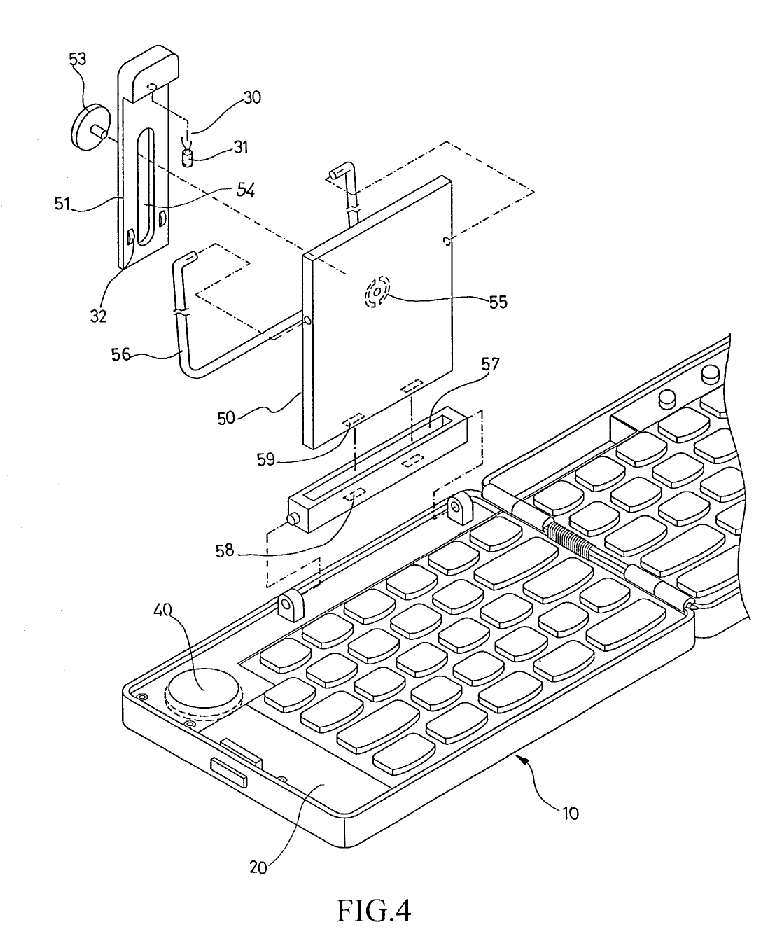

Based on above description and referring to FIG. 2 and FIG. 4, the revolving arm (51) is installed on the back of the holding stand (50); the infrared transmitter (30) is installed inside the side housing (52) of a revolving arm (51), the LED (31) of the infrared transmitter (30) can emit light toward inside. An adjustable knob (53) is on the back of the holding stand (50) and an inserting hole (54) is on the revolving arm (51). The adjustable knob (53) is vertical to and is inserted into the inserting hole (54) so as to make the revolving arm (51) stretchable and rotatable. A rotating conductor (55) is disposed on the holding stand (50), corresponding to the location of the adjustable knob (53), and is on the front of the revolving arm (51). Such arrangement makes the rotating conductor (55) can contact the connecting point (32) of the infrared transmitter (30) appearing on the lower part of the revolving arm (51); the other side of the rotating conductor (55) connects to the control circuitry (20) with internal wires. Based on above description, when the holding stand (50) and the revolving arm (51) are pulled out to the right position, the signals of the control circuitry (20) pass through the rotating conductor (55) and the connecting point (32), trigger the infrared transmitter (30) and emit out from the LED (31). Therefore, users can adjust the location of the revolving arm (51) based on the position of the infrared receiver (61) of the PDA (60) for best receiving angle.

Referring to FIG. 3 and FIG. 4, the holding stand (50) can be installed on the top portion of the keyboard structure. While apply, the holding stand (50) is lifted up and held firmly with a supporting harp (56) to hold the PDA (60) (as shown in FIG. 3). A holding slot (57) arranged on top of the keyboard structure can also hold the holding stand (50). Two contacting points (58) inside of the holding slot (57) can connect to the two contacting points (59) on the bottom of the holding stand (50). This embodiment can take the holding stand (50) out while not being used (as shown in FIG. 4).

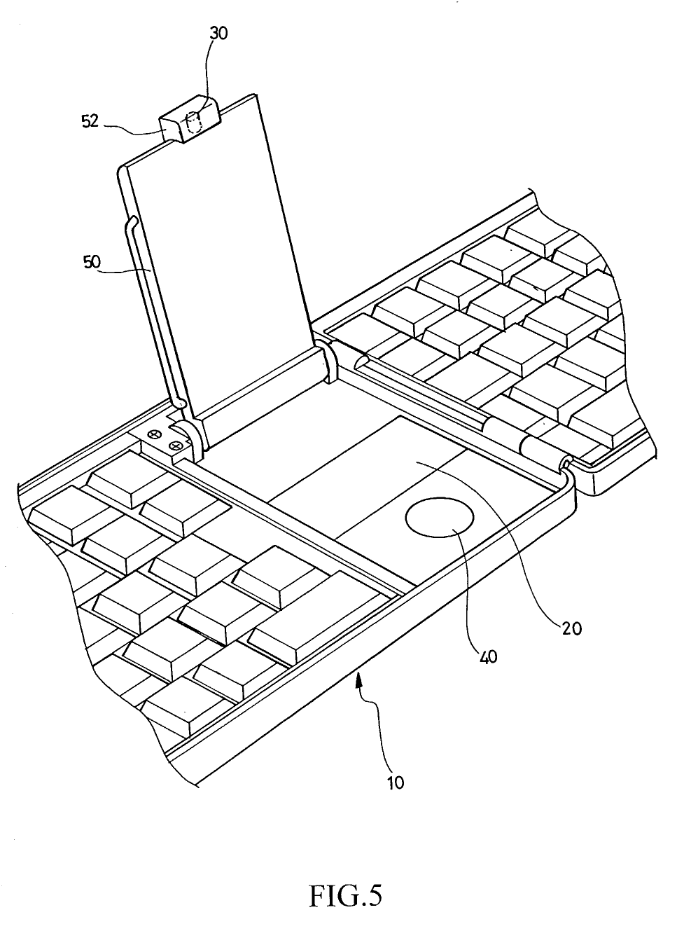

Referring to FIG. 5, the holding stand (50) is in a flat shape, fastened on one side and wraps to the top of the keyboard structure; while applying the holding stand (50) is lifted in 90° first.

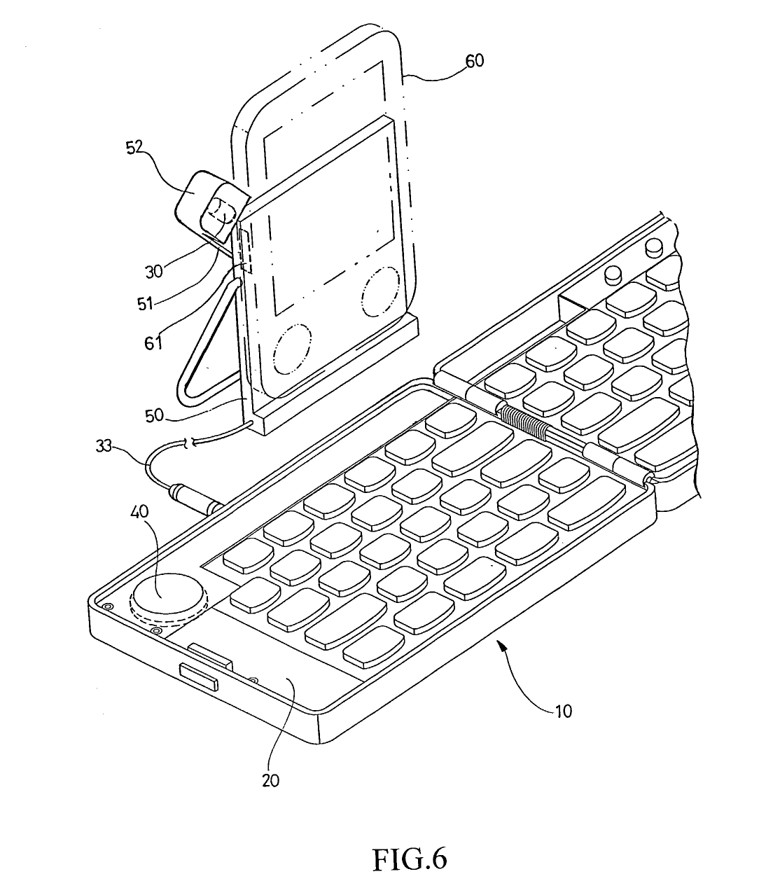

Referring to FIG. 6, the holding stand (50) is designed independently from the keyboard structure. A wire (33) connects between the infrared transmitter (30) of the holding stand (50) and the control circuitry (20) of the keyboard structure, such scheme can have the holding stand (50) work at a short distance.

While a preferred embodiment of the present invention has been shown and described in detail, it will be readily understood and appreciated that numerous omissions, changes and additions may be made without departing from the spirit and scope of the present invention.

What is claimed is:

1. A wireless PDA keyboard comprising:
a keyboard set;
an infrared transmitter transmitting data to PDAs;
a control circuitry converting the signals from said keyboard set into said infrared transmitter;
a battery set for offering the power;
a holding stand having a angle adjustable revolving arm with a side housing that contains said infrared transmitter;
wherein said infrared transmitter is installed inside said side housing of said revolving arm on back side of said holding stand; by adjusting the direction of said revolving arm, said infrared transmitter faces a corresponding infrared receiver of PDAs.

2. The wireless PDA keyboard recited in claim 1, wherein said infrared transmitter having a LED emitting light toward inside; an adjustable knob is arranged on back side of said holding stand and an inserting hole is on said revolving arm; said adjustable knob is vertical to and is inserted into said inserting hole so as to make said revolving arm stretchable and rotatable; a rotating conductor is disposed on said holding stand, corresponding to the location of said adjustable knob; said rotating conductor contacts the connecting point of said infrared transmitter appearing on the lower part of said revolving arm; the other side of said rotating conductor connects to said control circuitry with internal wires.

3. The wireless PDA keyboard recited in claim 1, wherein a wire connects between said infrared transmitter of said holding stand and said control circuitry of the keyboard structure.
